(19) United States
(12) Patent Application Publication
(10) Pub. No.: US 2004/0231079 A1
(43) Pub. Date: Nov. 25, 2004

(54) Single brush power driven scarifying tool for pipe ends

(76) Inventors: Albert Bierria, New Orleans, LA (US); Gwendolyn Bierria, New Orleans, LA (US)

Correspondence Address: Albert Bierria, 5286 Warrington Dr., New Orleans, LA, 70122, US

(21) Appl. No.: 10/442,291

(22) Filed: May 20, 2003

(51) Int. Cl. B08B 9/02

(52) U.S. Cl. 15/88; 15/104.04; 15/104.095

(57) ABSTRACT

A pipe end cleaning tool that attaches to a drill power source and comprise of a housing, a roller system, and an abrasive brush. The roller is designed to maintain continuity unto the brush as it rotates. As the abrasive brush wears down, the roller can be adjusted by either moving it onto new holes located on the housing, a worm driven adjustment on the housing, or spring loaded. The results are, the pipe ends gets cleaner and de-burred faster and the abrasive brush can be used to its maximum.

### CROSS-REFERENCE TO RELATED APPLICATIONS

This invention uses the transmission of our co-pending application. Application Ser. No. 10/191,271, Filing date Jul. 8, 2002.

### BACKGROUND-FIELD OF INVENTION

This invention relates to the cleaning and de-burring of metal pipe ends and metal pipefitting.

### BACKGROUND-DESCRIPTION OF PRIOR ART

Plumbers and HVAC contractors preparing to solder copper tubing have been hand sanding and steel brushing, a necessary process to make the solder ad-here to the copper tubing. This process is very time consuming and inefficient.

(a) The sand paper or emery cloth that is designed for this use is effective but, #1 These pieces of emery cloth get lost on the job site very easily. #2 When using emery cloth, you must use a vise, hold the pipe between your legs, or have someone else hold the pipe while being sanded. #3 When sanding small fittings, people with large fingers have a difficult time getting their fingers with the emery cloth into these small holes. #4 And because it is manual, this process is very slow, and time consuming.

(b) The wire brush/wire cup approach to cleaning copper tube fittings and pipe ends is better. #1 Different size brushes can reach into small holes of the fittings. And the wire cups can clean the pipe ends. #2 When used with a drill motor they work well, saving time and labor. The negative side to the wire brush/wire cup system is that you must change brushes or cups to accommodate the size pipe or pipe fitting you are trying to clean. And each time you do this there is a possibility of misplacing or losing these small tools.

(c) The other approach is the multi-head scarifying tool pat. No. 4,038,715. This tool has four wire brushes mounted on one tool. There are two different size wire brushes and two different size wire cups. The negative thing about this tool is, #1 when one of the heads wear out you cannot replace that specific head. #2 This is still a manual tool, and consequently slow, and inefficient. Also the tool is limited to the two sizes of pipe.

(d) The” Portable Power Driven Scarifying Tool For Pipe Ends, application # 10/191,271 date Jul. 8, 2002 is an excellent tool. #1 It cleans faster. #2 Worn parts can be changed. #3 Unlike the others, it can clean any size pipe without changing heads. #4 It is lightweight and portable. #5 The tool is very durable and easy to maintain. #6 You can use it manually. But, you can't get full use out of the brushes. Once a large gap develops between the brushes and the bushing bolts, you must change the brush.

### SUMMARY

All of these methods listed above, except for (d) “The portable power driven scarifying tool for pipe ends”, are manual and slow, and limited to cleaning size. With the exception of the single wire brush or wire cup on a drill motor, and that system wastes time in changing brushes to accommodate the pipe or fitting size.

### OBJECTS AND ADVANTAGES

Accordingly, beside the objects and advantages of the existing sanding, Single wire brushes, and the multi-head scarifying tool, with the exception of the “Portable Power

Driven Scarifying Tool For Pipe Ends”. They are:

(a) Inexpensive.

(b) Dependable.

(c) Simple.

However, our invention possesses all of the above advantages. Plus:

(a) Cleans pipe and fittings faster.

(b) Worn parts can be changed.

(c) Unlike the others, it can clean any size pipe with out changing heads.

(d) It is lightweight and portable.

(e) The tool is very durable and easy to maintain.

(f) Unlike the “The Portable Power Driven Scarifying Tool For Pipe Ends”, it has less moving parts, with the same results.

(g) Unlike the “The Portable Power Driven Scarifying Tool”, it has a movable bushing bolt. That enable the operator to adjust the bushing bolt closer to the brush head, as the brush wears down. This means the operator can get use of the entire brush, making the tool more cost effective.

(h) Unlike the “Portable Power Driven Scarifying Tool”, it is smaller and allows the operator to work in close quarters.

### REFERENCE NUMERALS IN DRAWINGS

FIG. 1/2

1 right side housing

2 left side housing

3 wire tube brush

4 bushing

5 bolt

6 set screws

7 washers

FIG. 2/2

1 housing

2 wire tube brush

3 bushing

5 bolt

7 washer

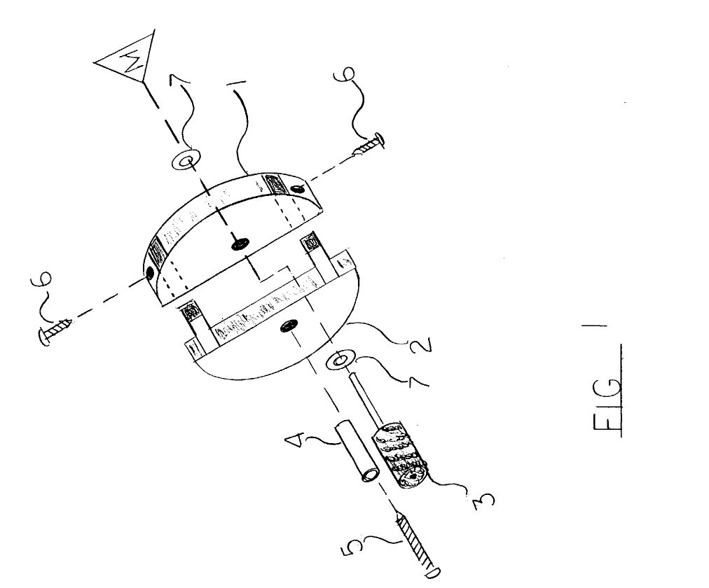

### DESCRIPTION-FIG 1- PREFERRED EMBODIMENT

1 in this preferred embodiment, this right side housing is made of plastic, such as (nylon). However the housing can consist of any other material that can stand up to the fatigue of friction, and fracturing, such as metal, etc. It consists of one hole in the center of the housing to receive 3 the shaft of the wire tube brush of prior art, and two slots located at either end to receive 2 the left side housing's prongs and 6 the set screws to hold the prongs in place 2 in this preferred embodiment, this left side housing is made of plastic, such as (nylon). However, the housing can consists of any other material that can stand up to the fatigue of friction, and fracturing, such as metal, etc. It consists of one hole in the center of the housing to receive 4 and 5 bushing and bolt, and has two prongs that are inserted into 1 the right side housing. The purpose of a two piece housing is to have the ability to move the 4 and 5 bushing and bolt towards the 3 wire tube brush as the brush wears down. 7 washers made-of steel welded on either side of 1 right side housing and onto 3 wire tube brush shaft, to secure 3 wire tube brush onto 1 housing.

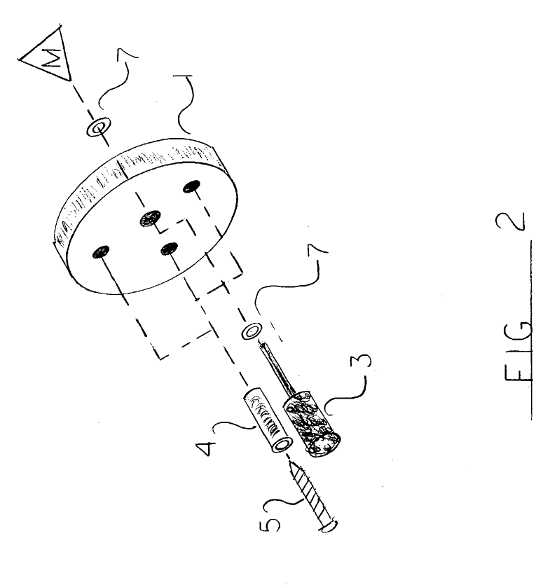

### DESCRIPTION-FIG 2- PREFERRED EMBODIMENT

1 in this preferred embodiment, this housing is made of plastic, such as (nylon). However the housing can consist of any other material that can stand up to the fatigue of friction, and fracturing, such as metal, etc. . . it consist of one hole in the center of the housing to receive 3 the shaft of the wire tube brush of prior art, and several other holes to receive 4 and 5 bushing and bolt. These holes vary in distance from the center hole, enabling the operator to have the ability to move 4 and 5 bushing and bolt closer to the 3 wire tube brush as the brush wears down. 7 washers made of steel welded on either side of 1 housing and onto 3 wire tube brush shaft, to secure 3 wire tube brush onto 1 housing.

### ADVANTAGES

From the description above, a number of advantages of our Single Brush Power Driven Scarifying Toll For Pipe Ends becomes evident.

(a) This tool is simple to operate.

(b) This tool cleans pipe ends and fittings very fast.

(c) Because this tool can be manufactured at such a low cost, it can be discarded when the brush is worn out.

(d) With the use of safety glasses and heavy gloves, which should always be used when working with wire brushes) is very safe to use.

(e) Because of its small size, its easy to use in tight quarters.

(f) Because this tool allows the operator to adjust the bushing/bolts closer to the brush, you will get full benefit of the entire wire brush.

(f) And most important this tool can clean pipe ends and fittings of all sizes without changing anything.

### OPERATION

The manner of using the Single Brush Power Driven Scarifying Tool For Pipe Ends.

A drill motor is attached to 3 the rear shaft of the wire tube brush. To clean the inside of the fitting, the operator should place the fitting with the 3 wire tube brush on the inside and the 4 and 5 bushing/bolt on the outside, and engage the motor. To clean the outside of the pipe, the operator should place the pipe with the 3 wire tube brush on the outside and the 4 and 5 bushing/bolt on the inside and engage the motor. For faster results, the operator should rotate the fitting or pipe with his or her free hand.

### CONCLUSION, RAMIFICATIONS, AND SCOPE

Accordingly, the reader will see that this Single Brush Power Driven Scarifying Tool For Pipe Ends, can clean pipe ends and fittings easily, quickly, and conveniently. And for the exception of the Portable Power Driven Scarifying Tool For Pipe Ends, it is far superior to any existing art. Furthermore, this tool has additional advantages in that:

Smaller and more economical to use.

it will remove loose metal, or burrs from saw pipe ends.

it will also remove debris from the threaded end of black and galvanized pipes.

Although the description above contains many specificities, these should not be construed as limiting the scope of the invention but as merely providing illustrations of some of the presently preferred embodiments of this invention. The housing can have other shapes, such as longer, wider, rounder, or squarer, etc.

We claim:

1. This single brush scarifying devise for cleaning pipe ends and pipe fittings is a tool comprising of:
a. A split housing that is made of plastic or metal that secures a wire tube brush and a bushing/bolt.
b. A split housing that is made to close unto the wire tube brush.
c. A split housing that is held together by set screws, set bolts, or barbs.
d. A split housing that has a wire tube brush's shaft penetrating through it to connect a drill motor.

2. This single brush scarifying devise for cleaning pipe ends and pipe fittings is a tool comprising of:
a. A solid housing that is made of plastic or metal and secures a wire tube brush and a bushing/bolt.
b. A solid housing that has many holes drill through it to hold a wire tube brush and the bushing/bolt. The other holes in the housing are to move the bushing/bolt closer to the wire tube brush as the brush wears down.
c. A solid housing that has a wire tube brush's shaft penetration through it to connect a drill motor.
